(19) United States
(12) Patent Application Publication
(10) Pub. No.: US 2015/0072824 A1
(43) Pub. Date: Mar. 12, 2015

(54) DECELERATION DEVICE FOR A DIRECTLY ELECTROMECHANICALLY ACTUATED PLANETARY GEAR ASSEMBLY IN A SEAT ADJUSTMENT MECHANISM AND METHOD FOR OPERATING A DECELERATION DEVICE

(71) Applicants: Andreas KAPPEL, (US); Johnson Controls GmbH, Burscheid (DE)

(72) Inventor: Ingo Kienke, Wermelskirchen (DE)

(73) Assignees: Johnson Controls GmbH, Burscheid (DE); Andreas KAPPEL, Brunnthal (DE)

(21) Appl. No.: 14/395,100

(22) PCT Filed: Apr. 19, 2013
(86) PCT No.: PCT/EP2013/058141

§ 371 Date: Oct. 17, 2014

(30) Foreign Application Priority Data
Apr. 20, 2012 (DE) 10 2012 007 758.0
Jul. 11, 2012 (DE) 10 2012 212 140.4

(51) Int. Cl. B60N 2/225; B60N 2/02

(52) U.S. Cl. CPC B60N 2/2254; B60N 2/2252; B60N 2/0224
USPC 475/153; 475/149

(57) ABSTRACT

A deceleration device is used for a directly electromechanically actuated planetary gear assembly in a seat adjustment mechanism. The deceleration device is integrated into the structural unit consisting of the planetary gear assembly and the electromechanical actuator therefor. Also described is a method for operating a deceleration device for a directly electromechanically actuated planetary gear assembly in a seat adjustment mechanism.

The invention relates to a deceleration device for a directly electromechanically actuated planetary gear assembly in a seat adjustment mechanism and a method for operating such a deceleration device.

In the prior art, planetary gears, in particular wobble mechanisms, of a seat adjustment mechanism are actuated manually or driven by means of a conventional electric motor and a self-locking gear unit.

It is the object of the present invention to specify a deceleration device which is improved relative to the prior art for a directly electromechanically actuated planetary gear assembly in a seat adjustment mechanism and a method which is improved relative to the prior art for operating such a deceleration device.

With regard to the deceleration device for a directly electromechanically actuated planetary gear assembly in a seat adjustment mechanism, the object is achieved by the features set forth in claim 1.

With regard to the method for operating such a deceleration device, the object is achieved by the features set forth in claim 10.

Advantageous developments of the invention form the subject matter of the sub-claims.

According to the invention, the deceleration device for a directly electromechanically actuated planetary gear assembly in a seat adjustment mechanism is integrated into a structural unit formed from the planetary gear assembly and the electromechanical actuation thereof. In this case, such an integration is understood as an arrangement of the deceleration device between the components of the planetary gear assembly and/or the electromechanical actuation thereof. In particular, the deceleration device is arranged inside a housing surrounding the planetary gear assembly and the electromechanical actuation thereof. As a result, a particularly compact structural unit consisting of the deceleration device, the planetary gear assembly and the electromechanical actuation thereof is formed.

Such a deceleration device permits a more efficient adjustment of a seat adjustment mechanism than a self-locking worm gear which has a significantly lower efficiency.

Particularly advantageously, by means of the deceleration device a use is possible of the directly electromechanically actuated open planetary gear assembly for a vertical and longitudinal adjustment and/or a backrest adjustment of a vehicle seat.

In a first variant which has particularly minimal costs, the deceleration device is configured as a permanently acting friction brake which introduces a predeterminable deceleration force as a frictional force into the planetary gear assembly. A self-locking of the planetary gear assembly is achieved by means of such a permanent frictional force below a locking limit.

In a preferred variant, the deceleration device is configured as a wedge brake which comprises at least one bearing ring, wedge elements, a retaining spring and the corresponding actuating means. In this manner, a deceleration device is possible, the deceleration force thereof being able to be controlled.

Expediently, an actuator for controlling the deceleration device is driven mechanically, electrically or electromechanically.

Preferably, the actuator of the deceleration device is arranged on the front face on the electromechanically actuated planetary gear assembly and acts through a hollow portion of an eccentric shaft or a through-hole of the shaped portion of the fitting part on the components of the deceleration device. As a result, easy accessibility and simple contact of the actuator is achieved.

In an advantageous embodiment, the planetary gear assembly is configured as a single open planetary gear. In this case, such an open planetary gear is a single planetary gear with only one central wheel and a connecting shaft of a planetary gear which does not circulate coaxially. In one possible embodiment, the central wheel is formed, for example, from the outer, internally toothed fitting part and the planet wheel from the inner, externally toothed fitting part of a conventional seat adjustment mechanism.

In a preferred embodiment, the planetary gear assembly is configured as a combination of two open planetary gears. As a result, particularly high torques may be produced at relatively low rotational speeds. A drive unit formed from a planetary gear assembly with a plurality of planetary gears is particularly compact and cost-effective.

In a particularly advantageous embodiment, the deceleration device is arranged between the two coupled open planetary gears and/or in the axial direction on the fitting part. In this manner, the deceleration device may be integrated particularly easily into the planetary gear assembly and advantageously apply a frictional force onto at least one component of the planetary gear assembly, resulting in a decelerating action.

In a particularly advantageous embodiment, the actuator of the deceleration device is arranged between the two coupled open planetary gears, so that a particularly compact unit is thus formed from the electromechanically actuated combination of two open planetary gears and the deceleration device.

In this manner, a deceleration device for an electromechanically actuated planetary gear assembly which is optimized, compact and cost-effective is possible.

In the method for operating a deceleration device for a directly electromechanically actuated planetary gear assembly in a seat adjustment mechanism, the deceleration device is controlled or regulated such that a decelerating action is effected during the stoppage of the electromechanically actuated planetary gear assembly and is cancelled directly before or at the start of an adjusting movement of the electromechanically actuated planetary gear assembly.

As a result, in a non-actuated state the deceleration device decelerates the planetary gear assembly and holds said assembly in a fixed position.

Thus such a planetary gear assembly with a deceleration device may be used for a vertical and longitudinal adjustment and/or a backrest adjustment of a vehicle seat, as in this application a decelerating action is required in order to avoid an inadvertent adjustment of the components of the vehicle seat. In particular, in the event of a crash, self-locking is particularly advantageous as this counteracts an adjustment of the vehicle seat due to the forces resulting from an accident which act thereon.

The invention is described in more detail with reference to the accompanying schematic figures, in which:

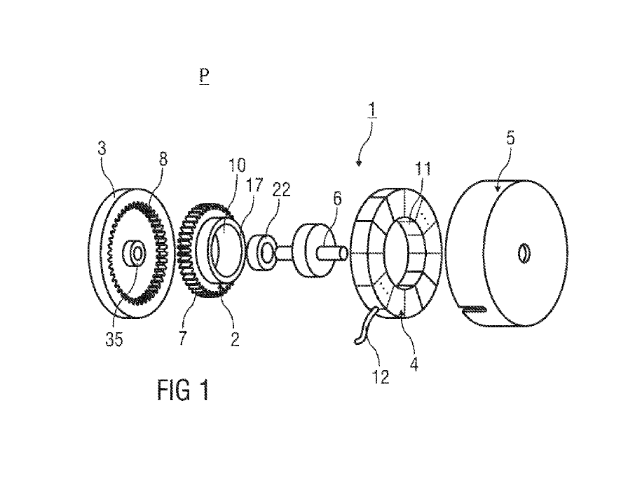

FIG. 1 shows schematically an exploded view of a planetary gear assembly as an electromechanically actuated planetary gear,

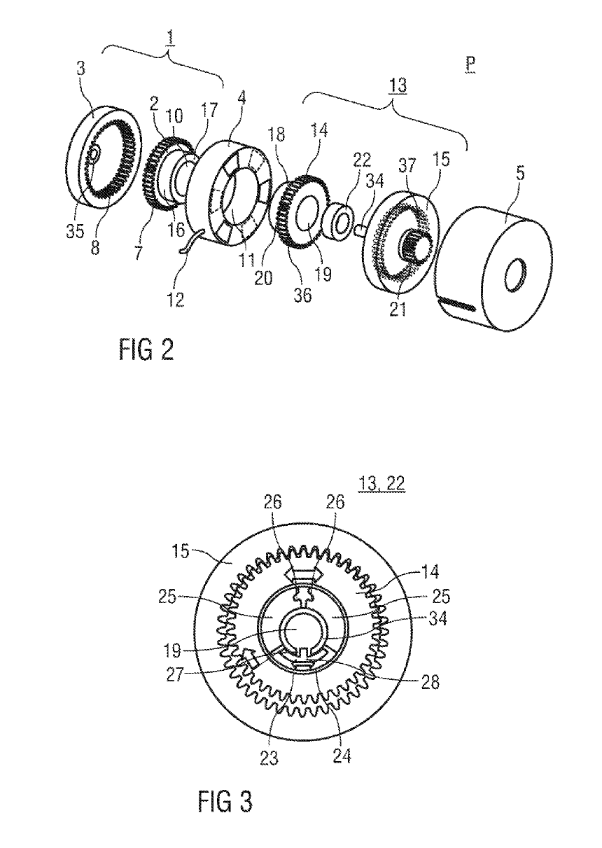

FIG. 2 shows schematically an exploded view of an electromechanically actuated planetary gear assembly as a combination of two open planetary gears,

FIG. 3 shows schematically a deceleration device according to the invention,

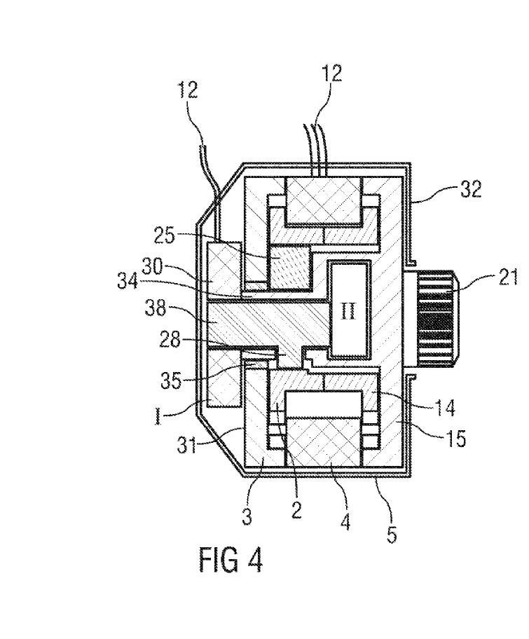

FIG. 4 shows schematically a sectional view of an electromechanically actuated planetary gear assembly as a combination of two open planetary gears with a rotationally actuated deceleration device,

FIG. 5 shows schematically a rotationally actuated deceleration device which is controlled depending on the direction of movement,

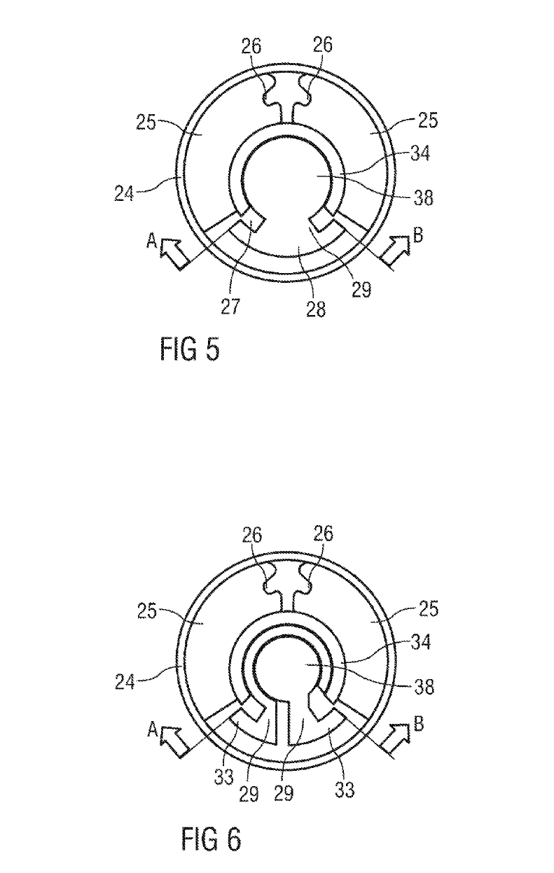

FIG. 6 shows schematically a rotationally actuated deceleration device which is controlled irrespective of the direction of movement and

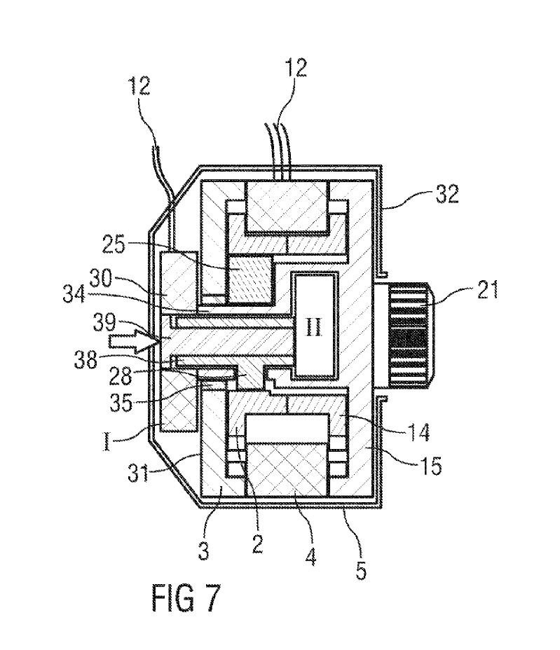

FIG. 7 shows schematically a sectional view of an electromechanically actuated planetary gear assembly as a combination of two open planetary gears with a deceleration device actuated in a linear manner.

Parts which correspond to one another are provided in all of the figures with the same reference numerals.

FIG. 1 shows schematically an exploded view of an electromechanically actuated planetary gear assembly P as an electromechanically actuated open planetary gear 1.

Such an open planetary gear 1 comprises at least one inner, externally toothed fitting part 2, an outer, internally toothed fitting part 3, a magnetic ring 4, a housing 5 and an eccentric shaft 6.

In a mounted state of the electromechanically actuated open planetary gear 1, which is ready for operation, the inner, externally toothed fitting part 2 is arranged at least partially or in regions in the outer, internally toothed fitting part 3 such that an external toothing 7 of the fitting part 2 is able to roll on an internal toothing 8 of the fitting part 3 in the conventional manner. In this case, the external toothing 7 and the internal toothing 8, with the same module, have a number of teeth which differs by at least one tooth, wherein the number of teeth of the internal toothing 8 is greater than the number of teeth of the external toothing 7.

The fitting parts 3 and 2 are preferably shaped by a non-cutting shaping process, for example as a sheet metal stamped part, sheet metal punched part, die cast part, from a metal material or a fiber reinforced plastics or a plastics mixture.

During operation of the electromechanically actuated open planetary gear 1, the fitting part 2, in a manner not shown, is rotatably arranged on the fitting part 3 and, for example, held by means of the housing 5.

The eccentric shaft 6 is configured in the form of a shaft on which preferably an eccentric portion 9 is centrally arranged. The eccentric shaft 6 is rotatably arranged with a first shaft portion in a bearing of the fitting part 3 and with its eccentric portion 9 is rotatably arranged in a central recess 10 of the fitting part 2.

The recess 10 and the eccentric portion 9 are shaped such that the constructional space for the components of the deceleration device 22 is produced between the recess 10 and the eccentric portion 9. The magnetic ring 4 is preferably formed from a plurality of magnetic coils arranged in an annular manner. In this case, an internal periphery 11 of the magnetic ring 4 is formed so as to correspond to the fitting part 2 and the wobble movement thereof along the internal toothing 8 of the fitting part 3, wherein ‘wobble movement’ is denoted as a movement about a rotational axis which alters in the spatial position thereof.

The magnetic ring 4 is preferably arranged fixed to a framework on the front face on the fitting part 3.

At least one multi-core electrical connecting cable 12 is arranged on the magnetic ring 4.

During operation of the electromechanically actuated open planetary gear 1 the individual magnetic coils of the magnetic ring 4 are activated one after the other so as to overlap in the peripheral direction of the magnetic ring 4, so that the respective magnetic field thereof acts on the inner, externally toothed fitting part 2, and sets said fitting part into a rotational wobble movement. This wobble movement is transmitted to the eccentric portion 9 of the eccentric shaft 6 and effects a rotation of the eccentric shaft 6.

By means of the deceleration device 22, the planetary gear 1 may be stopped and secured against inadvertent movement.

FIG. 2 shows schematically an alternative exemplary embodiment for a planetary gear assembly P in an exploded view as a combination of two open planetary gears 1, 13 which form a geared motor.

In the planetary gear assembly P, as a combination of two open planetary gears 1, 13 to form a geared motor, both open planetary gears 1, 13 are mechanically coupled together. In this case, the second open planetary gear 13 comprises a second inner, externally toothed fitting part 14 and a second outer, internally toothed fitting part 15 which are operatively connected together as already described with reference to the planetary gear 1, and roll against one another in the conventional manner.

The first inner, externally toothed fitting part 2 of the first planetary gear 1 and the second inner, externally toothed fitting part 14 of the second planetary gear 13 are, in a manner not shown, rotatably held in and/or on the fitting part 3. To this end, the fitting parts 2 and 14 are coupled fixedly in terms of rotation or rigidly together.

The first inner fitting part 2 has a shaped portion 16 into which the recess 10 is incorporated as a through-hole 17. The second inner fitting part 14 has a shaped portion 18 in which a further through-hole 19 is incorporated. In this case an outer periphery 20 of the shaped portion 18 of the fitting part 14 is shaped so as to correspond to the through-hole 17 of the fitting part 2, so that the shaped portion 16 of the first inner, externally toothed fitting part 2 and the shaped portion 18 of the second inner, externally toothed fitting part 14 may be arranged on one another on the front face by a positive, material and/or non positive connection. As a result, during operation, the fitting parts 2 and 14 are arranged in a rotationally fixed manner relative to one another and are mechanically operatively connected together. The respective length of the shaped portions 16 and 18, in this case, may be adjusted in a variable manner. For example, a long shaped portion 16 may be combined with a short shaped portion 18 and vice versa.

The first inner, externally toothed fitting part 2 is arranged in the outer, internally toothed fitting part 3 such that an external toothing 7 of the fitting part 2 is able to roll on the internal toothing 8 of the fitting part 3 in the manner already disclosed.

In this exemplary embodiment, the eccentric shaft 6 comprises a first eccentric portion 34 which is partially arranged inside the bearing 35 and inside the through-hole 17 and 19 of the inner, externally toothed fitting parts 2 and 14. At the end, on the end of the eccentric portion 34 opposing the bearing 35, in the region of the inner, externally toothed fitting part 14 on the eccentric shaft 6, a second outer, internally toothed fitting part 15 is arranged. This second outer, internally toothed fitting part 15 is arranged fixedly in terms of rotation on the eccentric shaft 6 and, in a manner not shown in more detail, is mounted in the housing 5 with as little friction as possible, for example mounted in a sliding manner, on rolling bearings or rollers.

The bearing 35 may be formed integrally in the fitting part 3 or may be arranged as a separate bearing 35, for example as a bearing bush in the fitting part 3.

In a mounted state of the electromechanically actuated planetary gear assembly P, which is ready for operation, consisting of the combination of two wobble mechanisms 1 and 13, the second inner, externally toothed fitting part 14 is arranged at least partially or in regions in the second outer, internally toothed fitting part 15 such that an external toothing 36 of the fitting part 15 may roll in the conventional manner on an internal toothing 37 of the fitting part 14, resulting in a relative movement between the fitting parts 14 and 15. In this case, the external toothing 36 and the internal toothing 37, with the same module, have a number of teeth which differs by at least one tooth, wherein the number of teeth of the internal toothing 37 is greater than the number of teeth of the external toothing 36. The fitting parts 14 and 15 are in this case preferably shaped by means of a non-cutting shaping process, for example as a sheet metal stamped part.

In this case, the difference in the number of teeth and/or an absolute number of teeth of the respective internal toothings 8, 36 and external toothings 7, 37 may differ between the wobble mechanisms 1 and 13 coupled together. In particular, a variation of the absolute number of teeth and/or the respective difference in the number of teeth of the wobble mechanisms 1 and 13, in particular the teeth thereof 7, 8, 36, 37, produces a different gear reduction of the planetary gear assembly P, wherein the coupled wobble mechanisms 1 and 13 have the same eccentricity.

During operation of the planetary gear assembly P, the fitting part 15 is held rotatably on the fitting part 14 in a manner not shown.

The magnetic ring 4 axially encloses or surrounds the shaped portion 18 of the second internally toothed fitting part 14 and the shaped portion 16 of the first internally toothed fitting part 2, so that the fitting parts 2 and 14 in each case are arranged on the front face on the magnetic ring 4.

During operation of the electromechanically actuated planetary gear assembly P, the individual magnetic coils of the magnetic ring 4 are activated one after the other so as to overlap in the peripheral direction of the magnetic ring 4, so that the respective magnetic field thereof acts on the two coupled inner, externally toothed fitting parts 2 and 14 and sets said fitting parts into a rotational wobble movement. In this case, the external toothing 7 of the first inner, externally toothed fitting part 2 rolls along the internal toothing 8 of the first outer, internally toothed fitting part 3.

The external toothing 36 of the second inner, externally toothed fitting part 14 rolls along the internal toothing 37 of the second outer, internally toothed fitting part 15. As a result, the second outer, internally toothed fitting part 15 is set into a rotational movement relative to the first outer, internally toothed fitting part 3.

By means of this variant, a particularly slow-running electromechanically actuated planetary gear assembly P is possible.

During an operation of the geared motor, which is formed from the electromechanically actuated planetary gear assembly P and thus the electromechanically actuated open planetary gears 1, 13 coupled together, as part of an inclination, longitudinal or vertical adjustment device, a spur gear 21 is preferably arranged on the eccentric shaft 6.

A deceleration device 22 is preferably arranged in the region between the two wobble mechanisms 1, 13 and/or in the axial direction on the fitting part 3 and acts on the eccentric shaft 6.

FIG. 3 shows schematically a deceleration device 22 according to the invention.

In a first variant, not shown, the deceleration device 22 is configured as a permanently acting friction brake which introduces a predeterminable deceleration force as a frictional force into the open planetary gear(s) 1, 13 and, for example, acts on the eccentric shaft 6. By means of such a permanent frictional force below a locking limit, a self-locking of the open planetary gear 1, 13 is achieved. For applying the deceleration force a spring acts with a predeterminable spring force permanently on the wedge elements 25.

In a preferred variant, the deceleration device 22 is configured as a conventional wedge brake.

The wedge elements 25 are forced apart in the peripheral direction by bent-back spring ends of a spring, not shown, so that any clearance in the toothing and in the bearing is avoided. To this end, the spring ends engage in recesses 26 of the wedge elements 25 by pretensioning.

An actuation, in particular the lifting, of the wedge elements 25 effects a relative movement of the wedge elements 25 and the actuating means 28 and thus a release of the deceleration device 22 which in a non-actuated state decelerates the planetary gear assembly P and holds said assembly in an unalterable position.

For actuating the wedge elements 25, the through-hole 19 of the eccentric portion 34 of the fitting part 14 is widened by means of a groove-shaped opening 27. A corresponding bearing portion 38 of an actuating means 28 is arranged in the through-hole 19. A transmission portion 29 of the actuating means 28 is arranged in the opening 27 such that the actuating means 28 is partially pivotable in the peripheral direction of the eccentric portion 34.

For releasing the deceleration force of the wedge elements 25, the actuating means 28 is pivoted so that the actuating means 28 and eccentric portion 34 come to bear against one another, wherein the deceleration device 22 is released and subsequently, when rotating the planetary gear assembly P, a common further movement takes place in the rotational direction of the planetary gear assembly P.

FIG. 4 shows schematically a sectional view of an electromechanically actuated planetary gear assembly P as a combination of two open planetary gears 1, 13 with a rotationally actuated deceleration device 22.

A release of the deceleration device 22 takes place by means of a conventional actuator 30 which is advantageously configured mechanically, electrically or electromechanically.

In a first variant, the deceleration device 22 is released rotationally by means of the actuator 30, i.e. the actuator 30 performs a rotational movement which effects the actuation of the wedge elements 25.

In a first variant, the actuator 30 of the deceleration device 22 is arranged on the front face at a first position I on the electromechanically actuated open planetary gear 1. In this case, the first position I is configured on the front face 31 opposing the output side 32 of the electromechanically actuated planetary gear assembly P as a combination of two open planetary gears 1, 13.

In this case, the actuator 30 acts indirectly through a hollow portion of the eccentric shaft 6 or the through-hole 19 of the shaped portion 18 of the fitting part 14 on the components of the deceleration device 22, in particular the wedge elements 25.

In an alternative variant, the actuator 30 of the deceleration device 22 of an electromechanically actuated planetary gear assembly P is arranged as a combination of two open planetary gears 1, 13 in the region between the two coupled planetary gears 1, 13 at a second position II. Thus a particularly compact unit consisting of the electromechanically actuated planetary gear assembly P as a combination of two open planetary gears 1, 13 and the deceleration device 22 is formed.

FIG. 5 shows schematically a rotationally releasing deceleration device 22 which is controlled depending on the direction of movement of the actuator 30. In this case, a pivoting movement of the actuating means 28 effects in the direction A a release of the corresponding wedge element 25 and thus a partial release of the deceleration device 22, as the other wedge element 25 also applies a frictional force. After the actuating means 28 and eccentric portion 34 come to bear against one another during the rotation of the planetary gear assembly P in the direction A, a combined further movement of all components takes place in the rotational direction of the planetary gear assembly P.

A pivoting movement of the actuating means 28 in the opposing direction B effects a release of the other wedge element 25 and a partial release of the deceleration device 22. Accordingly, a rotational direction of the planetary gear assembly P is oriented in the direction B.

FIG. 6 shows schematically a rotationally releasing deceleration device 22 which is controlled irrespective of the direction of movement of the actuator 30. In this variant, the actuating means 28 is configured in two parts and, in particular, has two opposing pivotable actuating portions 33. An actuation of the actuating means 28 effects a pivoting movement of the one actuating portion 33 in the direction A toward the corresponding wedge element 25 whilst at the same time the other actuating portion 33 in the direction B pivots toward the corresponding wedge element 25. Thus the two actuating portions 33 are spread apart. In this manner, both wedge elements 25 are activated together, irrespective of the direction of movement of the actuator 30 and the deceleration device 22 is fully released.

FIG. 7 shows schematically a sectional view of an electromechanically actuated planetary gear assembly P as a combination of two open planetary gears 1, 13 with a deceleration device 22 actuated in a linear manner.

In this variant, the deceleration device 22 is released in a linear manner by means of the actuator 30, i.e. the actuator 30 performs a linear movement which effects the release of the wedge elements 25.

In this case, the linear movement takes place in the axial direction of the eccentric shaft 6 and by corresponding means, for example an actuating rod 39, said linear movement is converted into a pivoting movement of the actuating means 28. Such a means for converting the action may, for example, be configured according to the wedge principle or screw thread principle.

In a first variant, the actuator 30 of the deceleration device 22 is arranged on the front face at the first position I on the electromechanically actuated open planetary gear 1.

In this case, the actuator 30 acts through a hollow portion of the eccentric shaft 6 or the through-hole 19 of the eccentric portion 34 of the fitting part 14 indirectly on the components of the deceleration device 22, in particular the wedge elements 25.

In an alternative variant, the actuator 30 of the deceleration device 22 of an electromechanically actuated planetary gear assembly P as a combination of two open planetary gears 1, 13 is arranged in the region between the two coupled planetary gears 1, 13 at a second position II. Thus, a particularly compact unit made up of the electromechanically actuated planetary gear assembly P, as a combination of two open planetary gears 1, 13 and the deceleration device 22, is formed.

### LIST OF REFERENCE NUMERALS

1 Electromechanically actuated open planetary
gear
2 Inner, externally toothed fitting part
3 Outer, internally toothed fitting part
4 Magnetic ring
5 Housing
6 Eccentric shaft
7 External toothing
8 Internal toothing
9 Eccentric portion
10 Recess
11 Internal periphery
12 Connecting line
13 Second open planetary gear
14 Second inner, externally toothed fitting part
15 Second outer, internally toothed fitting part
16 Shaped portion
17 Through-hole
18 Shaped portion
19 Through-hole
20 External periphery
21 Spur gear
22 Deceleration device
23 Internal periphery
24 Bearing ring
25 Wedge element
26 Recess
27 Opening
28 Actuating means
29 Transmission portion
30 Actuator
31 Front face
32 Output side
33 Actuating portion
34 Eccentric portion
35 Bearing
36 External toothing
37 Internal toothing
38 Bearing portion
39 Actuating rod
I First position
II Second position
A, B Direction
P Planetary gear assembly

1. A device for a seat adjustment mechanism, comprising:
a structural unit including an electromechanically actuated planetary gear assembly and an electromechanical actuation thereof; and
a deceleration device,
wherein the deceleration device is integrated into the structural unit.

2. The device as claimed in claim 1, wherein the deceleration device is a permanently acting friction brake which introduces a predeterminable deceleration force as a frictional force into the planetary gear assembly.

3. The device as claimed in claim 1, wherein the deceleration device is a wedge brake which comprises at least one bearing ring, wedge elements, a retaining spring and the corresponding actuating means.

4. The device as claimed in claim 1, wherein an actuator of the deceleration device is driven mechanically, electrically or electromechanically.

5. The device as claimed in claim 4, wherein the actuator of the deceleration device is arranged on the front face on the electromechanically actuated planetary gear assembly and acts through a hollow portion of an eccentric shaft or a through-hole of an eccentric portion of a fitting part on components of the deceleration device.

6. The device as claimed in claim 1, wherein the planetary gear assembly is configured as a single open planetary gear.

7. The device as claimed in claim 1, wherein the planetary gear assembly is configured as a combination of two open planetary gears.

8. The device as claimed in claim 7, wherein an arrangement between the two open planetary gears and/or in the axial direction on a fitting part.

9. The device as claimed in claim 1, wherein an actuator of the deceleration device is arranged between two coupled open planetary gears.

10. A method for operating a deceleration device for a directly electromechanically actuated planetary gear assembly in a seat adjustment mechanism, comprising:
controlling or regulating the deceleration device such that a decelerating action is effected during the stoppage of the electromechanically actuated planetary gear assembly and is cancelled before or at the start of an adjusting movement of the electromechanically actuated planetary gear assembly.
